(19) United States
(12) Patent Application Publication
(10) Pub. No.: US 2024/0388111 A1
(43) Pub. Date: Nov. 21, 2024

(54) Battery Charge Controller

(71) Applicant: Lenovo (Singapore) Pte. Ltd., New Tech Park (SG)

(72) Inventors: Bouziane Yebka, Morrisville, NC (US); Tin-Lup Wong, Morrisville, NC (US); Philip J. Jakes, Morrisville, NC (US)

(21) Appl. No.: 18/197,439

(22) Filed: May 15, 2023

(51) Int. Cl. H02J 7/00

(52) U.S. Cl. CPC H02J 7/00712; H02J 7/007194

(57) ABSTRACT

A method can include storing historic information for a battery; receiving real-time information for the battery; detecting a discharging rate abnormality of the battery by performing a comparison between the real-time information and the historic information; based on the discharging rate abnormality, selecting a charging rate for charging the battery; and charging the battery using the selected charging rate.

### TECHNICAL FIELD

Subject matter disclosed herein generally relates to rechargeable batteries.

### BACKGROUND

Electrochemical cells include, for example, lithium-based cells. Such cells may be characterized, for example, as to specific energy (e.g., Wh/kg or MJ/kg), energy density (Wh/l or MJ/l), specific power (W/kg), etc. Various technologies and techniques described herein pertain to electrochemical cells, for example, including lithium-based cells.

### SUMMARY

A method can include storing historic information for a battery; receiving real-time information for the battery; detecting a discharging rate abnormality of the battery by performing a comparison between the real-time information and the historic information; based on the discharging rate abnormality, selecting a charging rate for charging the battery; and charging the battery using the selected charging rate. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a battery;

FIG. 2 is a diagram of an example of a lithium-ion cell;

FIG. 3 is a diagram of an example of a lithium-ion cell where an anode electrode includes graphite;

FIG. 4 is a diagram of an example of a device;

FIG. 5 is a diagram of an example of a method;

FIG. 6 is a diagram of examples of plots;

FIG. 7 is a diagram of examples of plots;

FIG. 8 is a diagram of examples of plots;

FIG. 9 is a diagram of an example of a plot;

FIG. 10 is a diagram of examples of plots;

FIG. 11 is a diagram of an example of a plot and examples of control actions;

FIG. 12 is a diagram of an example of a method and an example of a system;

FIG. 13 is a diagram of examples of devices; and

FIG. 14 is a diagram of an example of a system.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

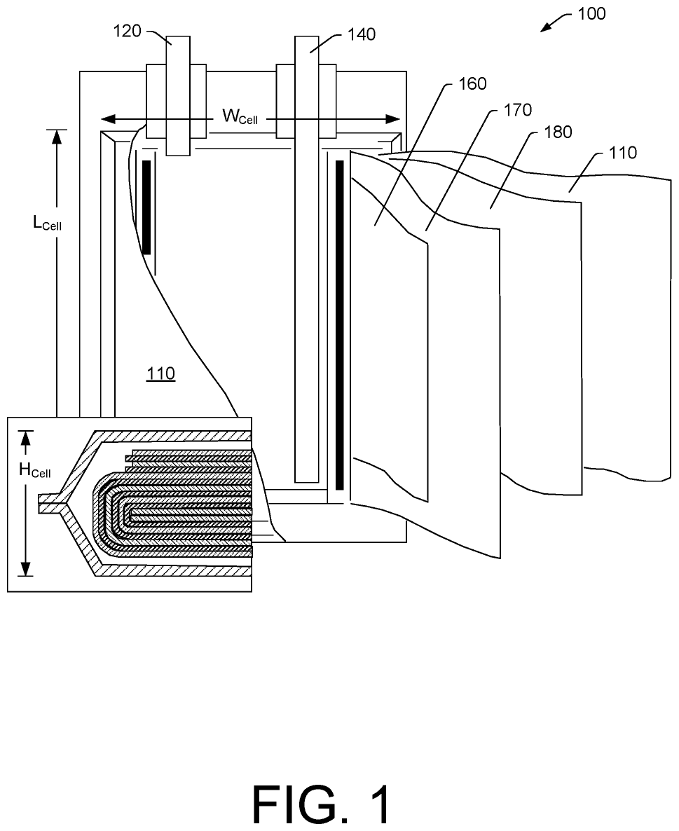

FIG. 1 shows an approximate cut-away view of an example of a battery 100 that includes a casing 110 and a positive tab 120 and a negative tab 140, for example, to operatively couple the battery 100 to circuitry. The casing 110 may include a cell region defined by a cell length (L_{Cell}), a cell width (W_{Cell}) and a cell height (H_{Cell}). As an example, the cell region may include one or more electrochemical cells. As an example, an electrochemical cell may be formed in part by a cathode 160, a separator 170 and an anode 180. Such components may be “folded”, for example, to form a stack (e.g., “jelly roll”) that may be housed in the cell region of the casing 110. As shown in the example of FIG. 1, in an approximate cross-sectional view, the height (H_{Cell}) of the cell region of the casing 110 may be defined in part by thicknesses of the cathode 160, the separator 170 and the anode 180 as well as, for example, by stacking of such components (e.g., winding in a roll or other configuration). As an example, a cathode formed of electrode material, an anode formed of electrode material and a separator formed of separator material along with collector materials may be layered and stacked, for example, by folding in a zigzag orientation, folding in a clockwise roll orientation, folding in a counterclockwise roll orientation, etc.

As an example, a region of a battery with one or more cells may include L_{Cell} and W_{Cell} dimensions (e.g., rectangular dimensions), for example, with a L_{Cell}/W_{Cell} ratio in a range of about 1 to about 5. As an example, consider a cell (or cells) with dimensions of about 120 mm (L_{Cell}) by about 100 mm (W_{Cell}) where, in combination with a height (H_{Cell}), a volume (Vol_{Cell}) may be calculated.

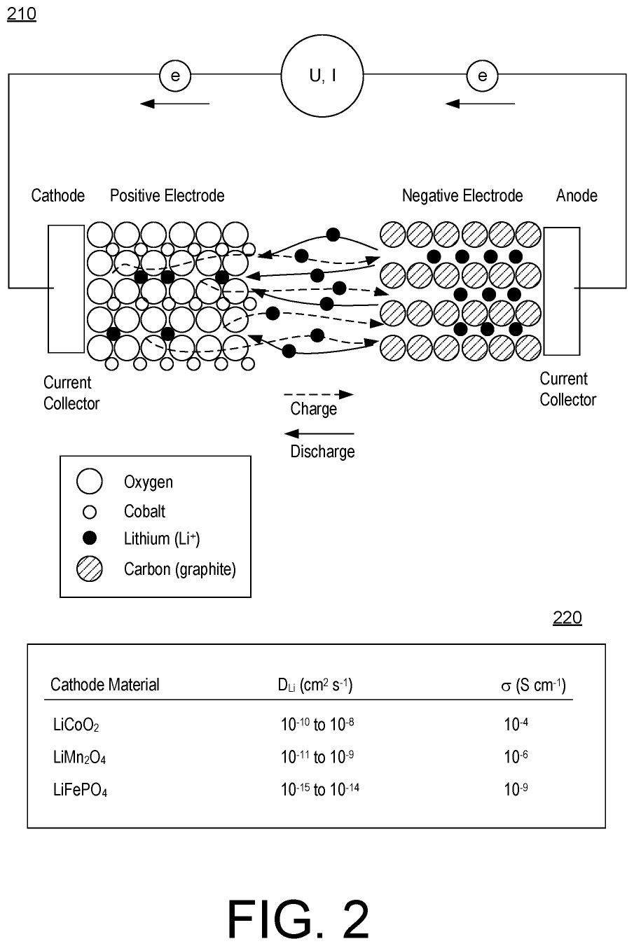

FIG. 2 shows a diagram of an example of a battery 210 and a table 220 that includes some examples of parameters for cathode materials (e.g., cathode electrode materials). In the example of FIG. 2, the battery 210 includes a cathode, an anode, a cathode current collector, an anode current collector, a positive electrode that includes oxygen and cobalt and a negative electrode that includes carbon (e.g., graphite, etc.). During charging, lithium ions (Li⁺) can pass from the positive electrode to the negative electrode and, during discharging, lithium ions (Li⁺) can pass from the negative electrode to the positive electrode. The table 220 shows some values for diffusion coefficients of lithium ions in various types of cathode materials that can function as positive electrodes (e.g., positive electrode materials or cathode materials) as well as some values for electrical conductivity of those various types of cathode materials.

In FIG. 2, the diffusion coefficient values are given in units of cm²s⁻¹ while the electrical conductivity values are given in units of Scm⁻¹. Diffusion may be described, for example, using one or more of Fick's laws. As to Fick's second law, it can be utilized to predict how diffusion can cause concentration to change with respect to time. In one dimension, consider the following partial differential equation:

$$\frac{\partial φ}{\partial t} = D \frac{{\partial }^{2} φ}{\partial {x}^{2}}$$

where φ is the concentration in dimensions of amount of substance per unit volume, which is dependent on time, where x is a position (e.g., length) and where D is the diffusion coefficient in units of length squared with respect to time (in two or more dimensions, the Laplacian may be utilized, as appropriate to generalize the second derivative).

According to Fick's second law, concentration and diffusion coefficient can impact diffusion where, for a given concentration, a smaller diffusion coefficient means a lesser change in concentration with respect to time. As can be seen in the table 220 of FIG. 2, the diffusion coefficients tend to be low and characteristic of solid materials (e.g., chemicals diffusing into or out of a solid matrix). For comparison, consider a volatile chemical diffusing in air where a diffusion coefficient may be of the order of about 0.1 cm²s⁻¹. Diffusion can play a role in behavior of a lithium ion battery, for example, discharging rate (e.g., diffusion of lithium ions into a cathode material) can depend on the chemical and/or physical structure of the cathode material of the lithium ion battery.

Diffusion can depend on temperature. For example, a diffusion coefficient for lithium ions can increase with temperature where, for example, at 50 degrees C., diffusion coefficient can be greater than that at 25 degrees C. Further, a diffusion coefficient for lithium ions at a relatively low temperature (e.g., 0 degrees C.) tends to be less than that at 25 degrees C.

During operation, heat can be generated responsive to current. Current transfer inside a lithium-ion battery (LIB) is driven by the potential gradient. In an article by Li et al., Three-Dimensional Thermal Modeling of Internal Shorting Process in a 20 Ah Lithium-Ion Polymer Battery, February 2020, Energies 13 (4): 1013, which is incorporated by reference herein, modeling results indicate for a particular LIB that current flow comes from a tab, goes into the whole cell, and goes back to a tab under normal discharging condition. Such current flow patterns can be utilized to model and characterize heat generation, dissipation and temperatures in LIBs. The article by Li et al., demonstrates that, under an internal shorting situation, current concentrates towards an internal short where, as the shorting resistance can be small, a large current can go through the internal short in an internal shorting process where the large current can then cause a sudden generation of heat, which may result in a detrimental thermal runaway. Thermal diffusion can be a factor in LIB operation as an inability to dissipate generated heat may lead to unstable operation (e.g., undesirable reactions), thermal stresses, etc.

As explained, a LIB can depend on diffusion of lithium ions where such diffusion can depend on temperature. And, temperature may be uneven within a LIB due to one or more factors, which can include current related factors, environmental factors, casing factors, etc. A LIB may benefit from a distribution of materials that can account for various factors such that, for example, spatial patterns of current, temperature and diffusion reduce risk of one or more performance issues (e.g., thermal hotspots, thermal runaway, thermal stresses, etc.) and/or improve performance.

Lithium-based cells (e.g., lithium-based batteries) can include lithium in one or more forms. Some types of lithium-based cells can be referred to as lithium-ion cells while other types can be referred to as lithium metal cells. As to the latter, consider, as an example, a rechargeable lithium metal battery that includes metallic lithium as a negative electrode (e.g., anode). In such an approach, the high specific capacity of lithium metal (3,860 mAhg⁻¹), very low redox potential (−3.040 V versus standard hydrogen electrode) and low density (0.59 gcm⁻³) make it a suitable anode material for high energy density battery technologies. Rechargeable lithium metal batteries can have a long run time due to the high charge density of lithium. Some rechargeable lithium metal batteries employ a liquid electrolyte and some employ a solid-state electrolyte.

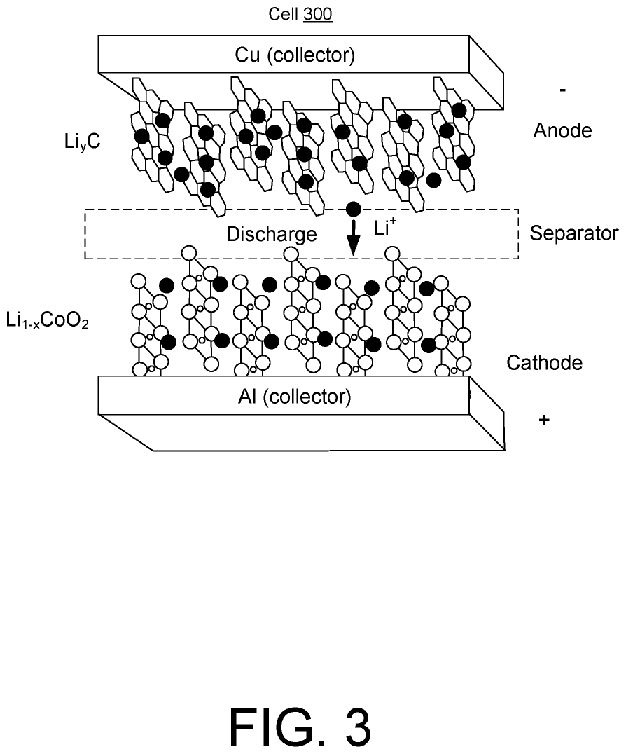

FIG. 3 shows an example of a cell 300, which may be utilized alone or to form a stack of cells. As shown, the cell 300 includes an anode collector material that includes, for example, copper; an anode electrode material that includes lithium and carbon (e.g., Li_{y}C); a separator material configured for passage of lithium ions (e.g., in electrolyte); a cathode electrode material that includes lithium and metal oxide (e.g., Li₁₋ₓCoO₂); and a cathode collector material that includes, for example, aluminum. While carbon, cobalt, copper and aluminum are mentioned, other materials may be employed to form a lithium-ion cell.

As to the terms “anode” and “cathode”, these may be defined based on discharge, for example, where lithium ions migrate in a direction shown in FIG. 3 from a carbon-based matrix towards a metal oxide-based matrix. In other words, when a lithium-ion based cell is discharging, a positively charged lithium ion may be extracted from anode electrode material (e.g., a graphite lattice) and inserted into cathode electrode material (e.g., into a lithium containing compound); whereas, when such a cell is charging, the reverse process may occur (see, e.g., FIG. 2).

As an example, positive electrode material (e.g., cathode electrode material) may include LiCoO₂, LiMn₂O₄ or other compound (see, e.g., the table 220 of FIG. 2). As an example, separator material may include a conducting polymer electrolyte (e.g. polyethyleneoxide (PEO), etc.). For example, a separator material may include polymer that provides for conduction of lithium ions (e.g., a lithium-ion conductive polymer material). As an example, negative electrode material (e.g., anode electrode material) may include ionizable lithium metal, a carbon-lithium intercalation compound, etc.

As an example, a lithium-ion battery may include one or more cells where each cell includes an anode, a cathode and electrolyte, which may be a polymeric material or provided in a polymeric matrix. As an example, a cell may include an anode electrode material that includes carbon, a cathode electrode material that includes a metal oxide, and a separator material that includes polymer.

As an example, active electrode particles may be used for a cathode to form cathode electrode material. For example, consider particles that include one or more of lithium cobalt oxide (LiCoO₂) (LCO), lithium nickel oxide (LiNiO₂), lithium manganese oxide (LiMn₂O₄), and lithium iron phosphate (LiFePO₄).

As an example, positive active electrode particles may include lithium and metal oxide, for example, represented by LiₓM¹_{y}M²_{1-y}O₂ where 0.4≤x≤1; 0.3≤y≤1; M¹ is at least one selected from the group consisting of Ni and Mn; and M² is at least one selected from the group consisting of Co, Al, and Fe. As an example, positive active electrode particles may include lithium and metal oxide, for example, be represented by one of the following: LiNiₓCo_{y}Al_{z}O₂, where 0.7≤x≤1; 0≤y≤0.3; 0≤z≤0.03; and 0.9≤x+y+z≤1.1; LiNiₓCo_{y}Mn_{z}O₂ (NMC), where 0.3≤x≤0.6; 0≤y≤0.4; 0.3≤z≤0.6; and 0.9≤x+y+z≤1.1; LiₓMn_{Z}O₂, where 0.4≤x≤0.6; and 0.9≤z≤1; or LiFeₓCo_{y}Mn_{Z}O₂, where 0.3≤x≤0.6; 0.1≤y≤0.4; 0.3≤z≤0.6; and 0.9≤x+y+z≤1.1. As an example, lithium iron phosphate (LiFePO₄) (LFP) may be utilized as an electrode material.

As an example, active electrode particles may be used for an anode to form anode electrode material. For example, consider particles that include one or more of carbon lithium and lithium titanate. As to lithium titanate, consider, for example: Li₂TiO₃; Li₄TiO₁₂; Li₄Ti₅O₁₂.

As an example, a cell may include electrolyte in a polymeric matrix. For example, consider an electrolyte that includes Li(ClO₄)₂ in polycarbonate/tetrahydrofuran (PC/THF) (e.g., about 0.4 M) or other polymeric matrix.

As an example, a cell can include a polymer composite material such as polyethylene oxide (PEO), polyacrylonitrile, etc. that includes lithium salt. Such a cell or cells may be referred to as a lithium-ion battery or a lithium-ion polymer battery or a lithium-polymer battery (e.g., “LiPo battery” or “LiPo cell”). LiPo cells are sometimes referred to as laminate cells, which may be configured very thin or quite large depending on their intended use. One or more LiPo cells may be encased in a flexible aluminum foil laminate pouch (e.g., with a thickness of the order of about 0.1 mm; see, e.g., the casing 110 of the battery 100 of FIG. 1). LiPo cells may include a stacked construction formed by stacking materials that include electrode and electrolyte materials in a flat sandwich (e.g., defined by length, width and height dimensions). Stacked layers may be packed in a package (see, e.g., the casing 110 of FIG. 1) in a flat, rolled or other configuration. LiPo cell capacities may include capacities in a range, for example of about 50 mA·hrs (e.g., for a small cell such as for a BLUETOOTH headset) to about 10 A·hrs or more for an electric vehicle (e.g., electric or hybrid).

As explained, in a lithium-ion cell, lithium ions can move from a negative electrode (e.g., anode) to a positive electrode (e.g., cathode) during discharge and reversely when being charged. As an example, a LiPo cell can include a polyethylene (PE), a polypropylene (PP), a PP/PE, or other material as a separator material. Some LiPo cells may include a polymer gel containing an electrolyte solution, which may be, for example, coated onto an electrode surface (e.g., as a separator material layer). As an example, a continuous layer of material may be provided that carries various materials where the continuous material may be folded to form a stack of materials. As an example, the continuous layer of material may be a separator material in that portions of it are disposed between layers of electrode materials (e.g., to separator anode electrode material from cathode electrode material).

As explained, batteries can rely electrochemical interactions for charging and discharging. Batteries can be subjected to use patterns, which may be dictated by humans, machines, or other factors. For example, a battery for a night light may charge during the day and discharge at night according to a schedule, a sensor, etc.; whereas, a battery for a computer may charge when plugged in and discharge when in use and not plugged in.

In various applications, charging and discharging may vary over time. For example, a computer may be stored for a period of time, which may be for a number of days, and then subsequently used for a number of hours. Such a storage and/or usage pattern may depend on a user's schedule, a user's needs, etc. For an optimal user experience, the user may expect a battery of a computer to perform consistently when charged to a certain level. For example, if a computer is stored with a battery in a full-charged state (e.g., 100 percent), the user may expect that the computer can be used for a number of hours before having to be plugged in. However, in some instances, for one or more reasons, the battery may not meet such expectations. While some battery performance degradation may be expected with respect to age, a rapid decline in battery performance may be unexpected and undesirable.

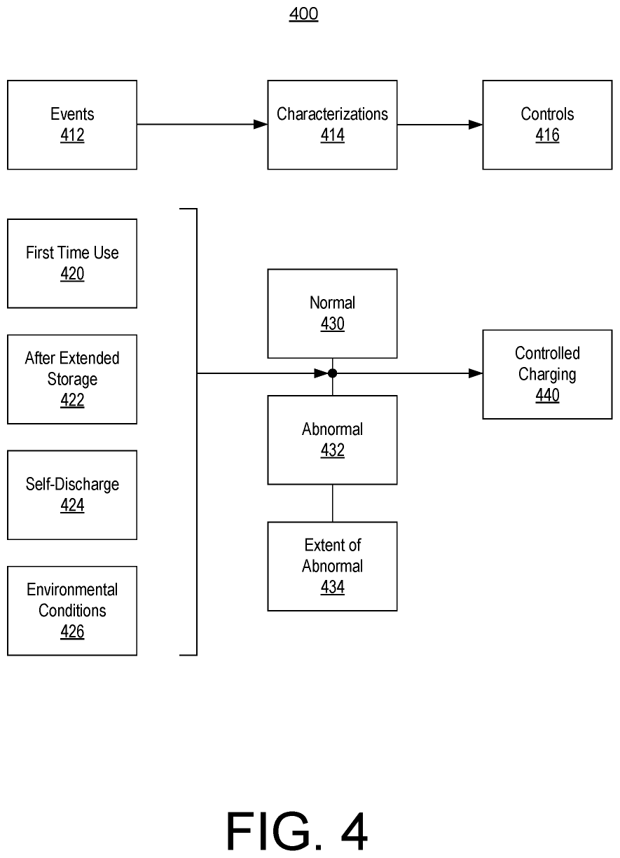

FIG. 4 shows an example of a method 400 that can provide for optimal charging of a battery, which may aim to increase battery performance and/or battery life such that battery performance more closely meets a user's expectation.

As shown in FIG. 4, the method 400 can include an event block 412 for detecting one or more events, a characterization block 414 for performing battery characterizations, and a controls block 416 for issuing one or more control actions.

In the example of FIG. 4, the event block 412 may provide for detection of events such as a first time use event 420, an after extended storage event 422, a self-discharge event 424 and one or more types of environmental conditions events 426.

As to the first time use event 420, consider a device that includes an original equipment manufacturer (OEM) battery or a new replacement battery (e.g., a field replaceable unit (FRU)). In such examples, a method can detect the first time use event, characterize the detected event and determine a control action to be implemented to control charging of the battery, which may occur after some amount of discharging.

As to the after extended storage event 422, consider a battery in a device that has been stored for a number of days that may be greater than a threshold to thereby indicated that the number of days equates to an extended storage period of the device. For example, consider a threshold of three days where storage longer than three days is considered an extended storage. As an example, a threshold may be set in a manner dependent on type of electrochemistry involved in a battery. For example, some types of electrochemistry may be more prone to extended storage issues than others. Further, environmental conditions can affect how a battery behaves while being stored. As an example, a fully charged battery stored at 104 deg F (40 deg C) may lose approximately 30 percent of its capacity in 3 months. Certain conditions may impact charge and/or capacity. For example, charge may be decreased over time during extended storage and/or capacity may be decreased over time during extended storage.

As to the self-discharge event 424, self-discharge can occur for one or more reasons. For example, consider a micro-short circuit, temperature, electrolytic solvents, moisture, state of charge (SOC), etc. As to a micro-short circuit, a small electrical current may leak into a battery, for example, if a battery gets wet, has electrolyte solvent or water in it, or if there are other small electrical components such as wiring that is touching it. Such a micro-short circuity may also happen when a battery is overcharged. As to temperature, at high temperatures, self-discharge can increase due to stability of an SEI layer (e.g., deteriorates and breaks where regenerating the SEI consumes more lithium), due to faster dissolution of positive electrode metal, due to electrons being more active (e.g., to participate in side reactions of negative electrode/electrolyte), and/or due to activity of the electrolyte being enhanced (e.g., side reactions between the electrolyte and the electrode are intensified). As to electrolytic solvents, electrolytic solutions can sometimes have substantial concentrations of solvents (e.g., strong acids like hydrochloric acid (HCl) which may dissolve some non-polar solids like plastics, rubber and even glass which can lead to leakage). As to moisture, it can be a common cause of increased self-discharge. Electrolyte solvent or water in a battery can dissolve due to moisture, which may create an imbalance in electrolyte of the battery. Such a scenario may generate an electric short, where a lithium-ion leak may result. As to SOC, at the same temperature, battery capacity under a high SOC condition decays faster because under a high SOC condition, a negative electrode can be in a lithium-rich state, which makes it easier to form an electron-ion-electrolyte complex, which exacerbates the reversible self-discharge of the battery. Self-discharge can be complex and, for example, may vary with respect to time (e.g., depending on conditions, phenomena, etc.). As mentioned, the rate of self-discharge tends to depend on temperature, where high and low temperatures can increase the rate (e.g., consider a desirable temperature being in a range from approximately 5 deg C to approximately 45 deg C). Various lithium-ion batteries have a self-discharge rate (e.g., self-discharging rate) of between approximately 0.5 percent and 3 percent per month. However, for a fully charged lithium battery, it may lose approximately 5 percent to approximately 10 percent of its charge over a month until it reaches a SOC of approximately 80 percent. For an SOC of approximately 30 percent to approximately 80 percent, a battery may have a more stable self-discharging rate (e.g., 0.5 percent or less).

As to the one or more environmental conditions event 426, these can include environmental conditions such as temperature, moisture (e.g., humidity), etc. Such conditions may be associated with one or more other events, for example, for purposes of characterization. As mentioned, storage time and conditions can impact self-discharge.

As an example, the characterization block 414 of the method 400 can provide for determining whether behavior of a battery is normal 430 or abnormal 432 and, for example, extent of abnormal 434. As an example, characterizations may be based on historic information, which may be stored to memory, analyzed to generate a model, etc., where real-time information may be utilized to make one or more comparisons. For example, real-time information may be rate of self-discharge information, which can be compared to historic self-discharge information to determine whether self-discharge rate is increasing, which may be indicative of an abnormality. Further, such a comparison may determine an extent to which behavior of the battery is abnormal. In the example of FIG. 4, the abnormality can be a discharging rate abnormality for the battery.

As an example, the controls block 416 can provide for issuance of one or more control actions for controlled charging 440 of a battery. For example, if a battery is characterized as abnormal (e.g., an abnormal discharging rate, etc.), the controls block 416 can respond by calling for an appropriate mode of charging, which may be conservative such that further reduction in battery performance is at least to some extent mitigated. As an example, consider a battery that is characterized as being abnormal due to a high rate of self-discharge, which can be referred to as a discharging rate abnormality. In such an example, the controls block 416 may issue a control action that calls for charging the battery to no more than an upper threshold SOC (e.g., consider 80 percent). In such an example, the controls block 416 may account for temperature where, for example, a storage and/or usage pattern may indicate a future temperature or temperatures during storage. If the future temperature or temperatures are outside of an optimal range, the controls block 416 may issue a notification to a user to adjust storage conditions to improve a battery's ability to retain charge during storage (e.g., “please store at a temperature between T1 and T2”). As another example, the controls block 416 may indicate a duration for storage such as, for example, to store for at most X number of days followed by use and/or charging. Such a notification may be issued electronically, for example, via network circuitry (e.g., to a remote device, etc.), local audio circuitry and/or local display circuitry.

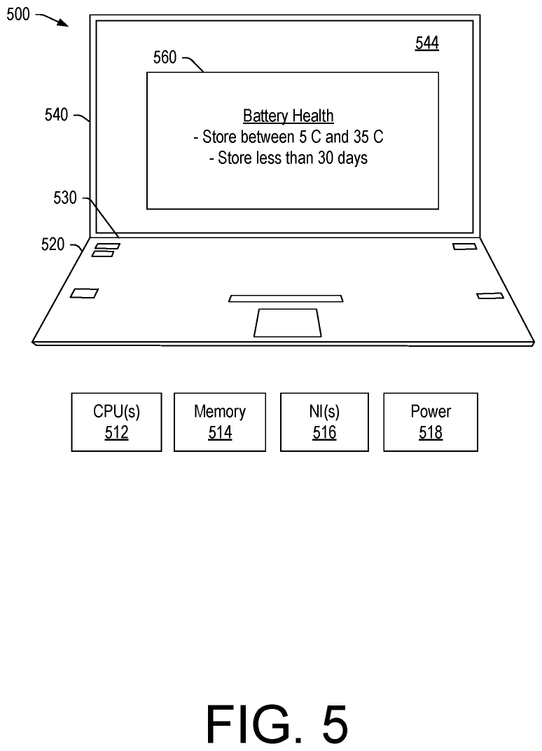

FIG. 5 shows an example of a computing device 500 that includes a base housing 520, a hinge assembly 530 and a display housing 540 with a display 544. As an example, the computing device 500 may include one or more processors 512, memory 514 (e.g., one or more memory devices), one or more network interfaces 516, and one or more power cells 518. Such components may be, for example, housed within the keyboard housing 520, the display housing 540, or the keyboard housing 520 and the display housing 540. In the example of FIG. 5, the computing device 500 can render a graphical user interface (GUI) 560 to the display 544. For example, consider the GUI 560 as being rendered with one or more notifications such as, for example, one or more of: “Store battery between 5 C and 35 C” and “Store less than 30 days”. In such an example, the computing device 500 can implement a method such as, for example, the method 400 of FIG. 4, where charging of a battery (e.g., the one or more power cells 518) can be controlled.

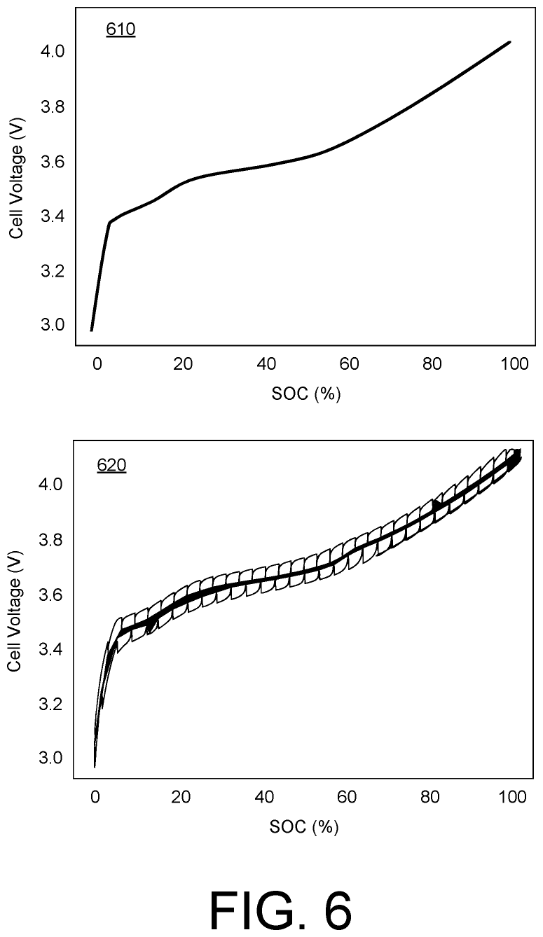

FIG. 6 shows example plots 610 and 620 of cell voltage in volts versus SOC in percent. In the plot 610, a non-incremental charging curve is shown where SOC is increased from 0 percent to 100 percent as cell voltage is increased from 3.0 volts to 4.0 volts. In the plot 610, the curve provides one data point per SOC value or per cell voltage value. In contrast, in the plot 620, an incremental charging curve is shown where SOC is increased from 0 percent to 100 percent incrementally as cell voltage is increased from 3.0 volts to 4.0 volts incrementally. As shown in the plot 620, multiple data points exist for each SOC value and for each cell voltage value.

As demonstrated in FIG. 6, incremental charging can increase the amount of information that can be generated where such information may be used for one or more purposes. For example, such information may be utilized to characterize behavior of a battery. In such an example, information may be stored as historic information, optionally in the form of one or more models (e.g., empirical, physics-based, machine-learning, etc.). As an example, real-time information may be analyzed, for example, by comparing it to historic information. In such an example, an analysis can provide for determining whether behavior of a battery is normal or abnormal, where, for the latter, an analysis may determine a degree of abnormality (e.g., a degree to which a discharging rate may be abnormal, etc.).

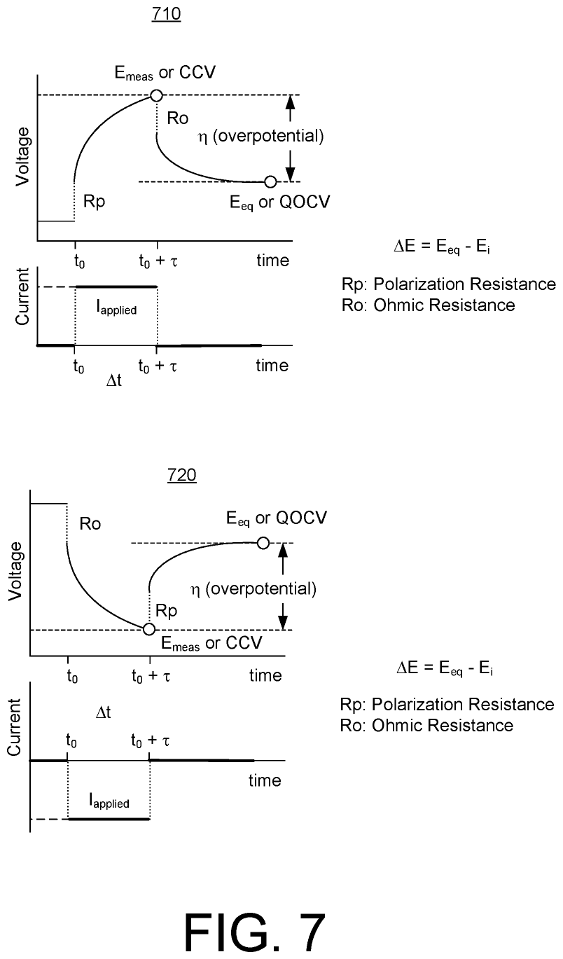

FIG. 7 shows example plots 710 and 720, which show voltage and current with respect to time for a current pulse as may be employed in incremental charging or incremental discharging. The plots 710 and 720 show how polarization resistance and ohmic resistance can be measured. Polarization resistance (Rp) accounts for ionic diffusion in the solid phase and can be considered to be the rate determining step for lithium-ion batteries. Ohmic resistance (Ro) includes electronic resistances and the bulk electrolyte ionic resistance of a battery. As shown in the plots 710 and 720, equilibrium potential (E_{eq}) or quasi-open circuit voltage (QOCV) and measured potential (Eₘₑₐₛ) or closed circuit voltage (CCV) can be determined.

As shown in the plots 710 and 720, a polarization effect causes a difference between CCV and OCV (e.g., QOCV). As shown in the plot 720, when discharging, the CCV is lower than OCV and the voltage rises to the QOCV after some amount of time after a load is eliminated.

Referring again to the plot 620 of FIG. 6, the additional information in comparison to the plot 610 includes CCV and OCV (e.g., QOCV) information that can be utilized to characterize a battery (e.g., battery behavior). For example, in the plot 620, resistances such as Rp and Ro can be characterized (e.g., during charging and/or during discharging).

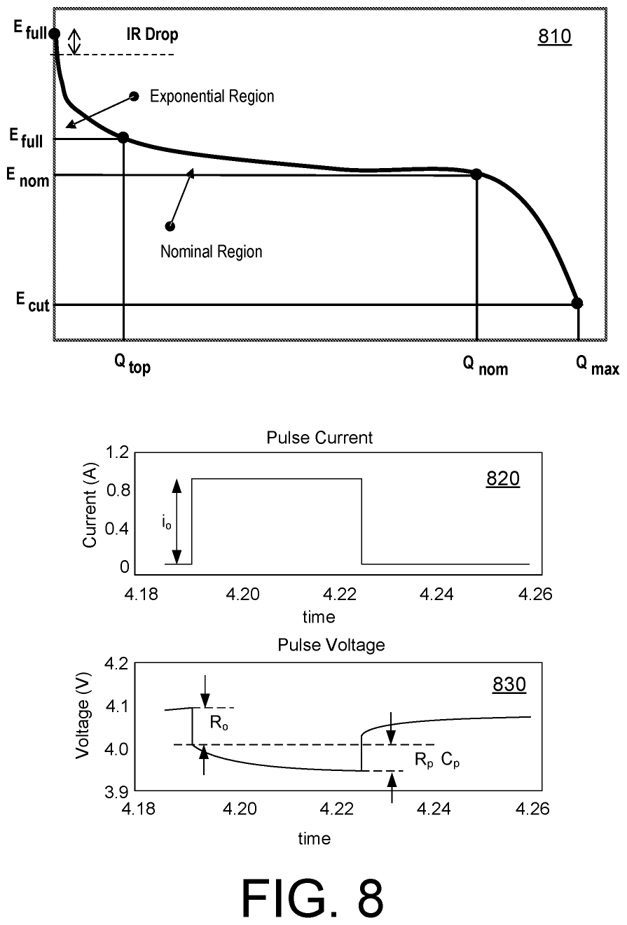

FIG. 8 shows example plots 810, 820 and 830, which show behavior with respect to a pulse current. As shown, the plot 810 shows discharge cutoff voltage (E_{cut}), full voltage (E_{full}), exponential point voltage (Eₜₒₚ), nominal voltage (Eₙₒₘ), maximum capacity (Qₘₐₓ), exponential point capacity (Qₜₒₚ) and nominal capacity (Qₙₒₘ). As shown in the example plot 810, the maximum capacity (Qₘₐₓ) corresponds to the discharge cutoff voltage (E_{cut}). However, as an example, a controller may control capacity with respect to cutoff voltage. For example, if a battery is characterized as exhibiting abnormal behavior, a cutoff voltage may be controlled in an effort to hinder a downward trend in performance.

In FIG. 8, the plot 820 shows a current pulse that is applied for a period of time (e.g., as in an incremental charging scheme), where the plot 830 shows a corresponding pulse voltage with respect to time. In the plot 830, Ro and Rp can be determined along with, for example, polarization capacitance (Cp).

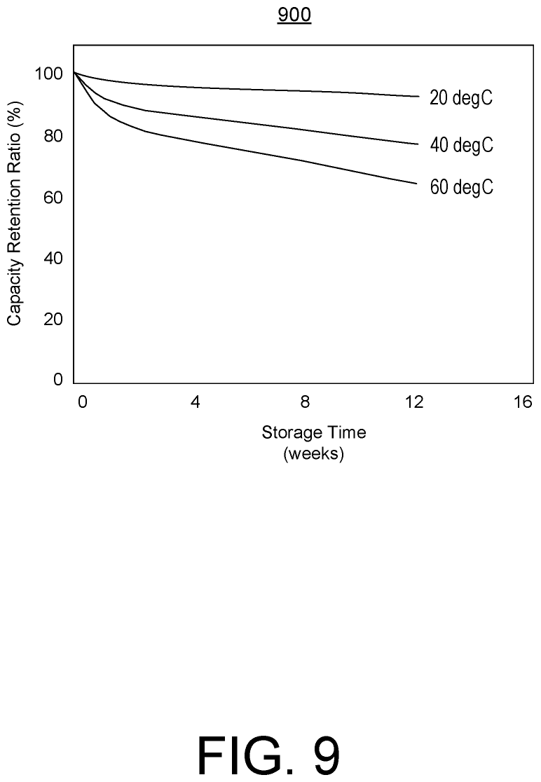

FIG. 9 shows an example plot 900 of capacity retention ratio in percent versus storage time in weeks for 20 deg C, 40 deg C and 60 deg C. As shown in the plot 900, the capacity retention ratio decreases with respect to storage time and with respect to increasing temperature from 20 deg C to 60 deg C. In the plot 900, the decrease tends to be more pronounced within the first week after which the decrease becomes less per week, which may be modeled, for example, using one or more linear models and/or one or more non-linear models. As an example, a model can account for temperature, storage time and optionally one or more other factors (e.g., SOC, etc.).

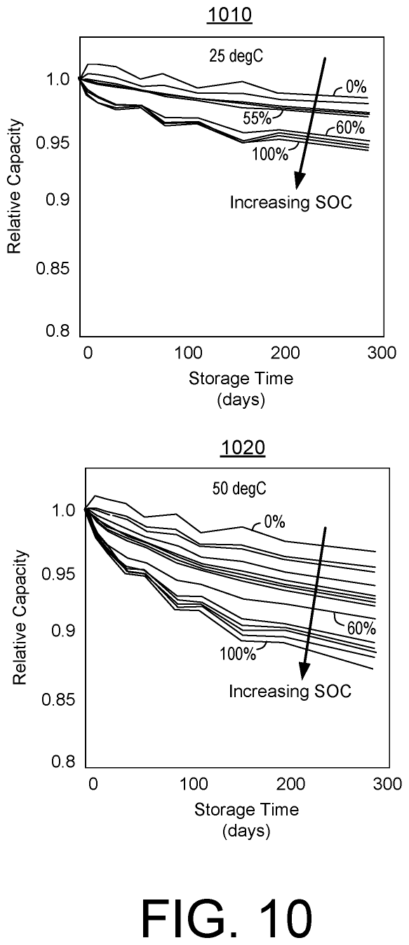

FIG. 10 shows example plots 1010 and 1020 of relative capacity, as a fraction, versus storage time in days, ranging from 0 days to 300 days (e.g., approximately 40 weeks), for different SOC percentages, ranging from 0 percent SOC to 100 percent SOC, and for two different temperatures, 25 deg C and 50 deg C.

As shown in the plots 1010 and 1020, the decrease in relative capacity depends on SOC where an increased SOC leads to a greater decrease in relative capacity. As mentioned, for elevated temperatures, such as, for example, 50 deg C, the decrease in relative capacity is amplified when compared to a lower temperature of 25 deg C. For example, for 100 percent SOC, after 280 days at 25 deg C, the relative capacity decreases to approximately 94 percent (e.g., 0.94); whereas, at 50 deg C, the relative capacity decreases to approximately 87.5 percent (e.g., 0.875).

As explained, information can be acquired using one or more sensors, one or more information sources, etc. For example, where a device is in a room and operatively coupled to a network, it may receive environmental information such as, for example, one or more of temperature and humidity. As an example, a device may include a temperature sensor and/or a humidity sensor that can be utilized to acquire environmental information. As an example, a device can include a clock or timer and/or may be operatively coupled to a clock or timer. In such an example, a device can determine time or times, which may correspond to use, storage, charging, discharging, etc.

As an example, a degree of abnormality (e.g., extent of abnormality) may be determined using historic information and real-time information. As an example, historic information may include information such as in the plots 1010 and 1020 of FIG. 10. In such an example, degree of abnormality may be determined by assessing a percent deviation from a projection (e.g., expected decrease). As explained, expected behavior can be utilized, which may be generated using historic information (e.g., raw, processed and/or in the form of one or more models). Aspects of behavior can include self-discharge, voltage drop, capacity drop, etc. As explained, a method can include charging and/or discharging a battery in a particular manner, which may involve incremental charging (e.g., incrementally applying a charging current) and/or incremental discharging (e.g., incrementally applying a discharging load).

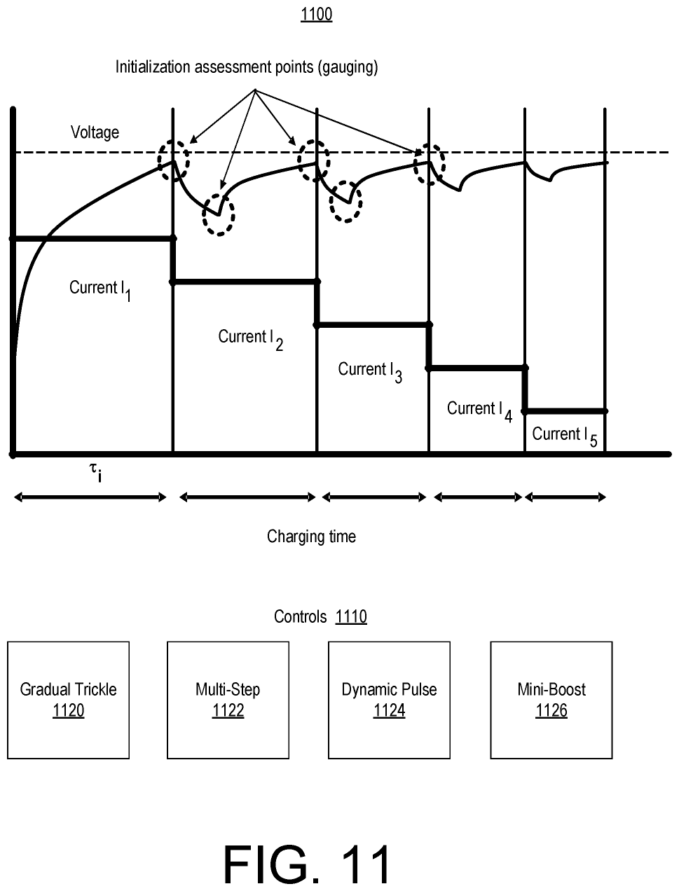

FIG. 11 shows an example of a plot 1100 and examples of controls 1110, presented as control blocks for a gradual trickle control 1120, a multi-step control 1122, a dynamic pulse control 1124, and a mini-boost control 1126. In the plot 1100, different current pulses, labeled one to five, are applied which have associated charging times (e.g., current pulse times or durations). In such an example, the current can be stepped down, which can include amplitude step down and/or duration step down, noting that one or more other schemes may be employed (e.g., step up, combinations of step up and step down, etc.). As explained, parameters such as polarization resistance (Rp) and ohmic resistance (Ro) may be determined responsive to application of a current pulse. Such parameters can provide for characterization of a battery. Such parameters may be part of historic information, which, as explained can be utilized in one or more methods for characterizing a battery, controlling charging and/or discharging of a battery, storing a battery, replacing a battery, etc.

As an example, a method may employ one or more of the controls 1110 as shown in FIG. 11, noting that one or more other controls may be employed, alternatively or additionally. As explained, a method can determine a control action to be implemented using information to determine whether battery behavior is normal or abnormal and, if abnormal, an extent to which the battery behavior is abnormal. As explained, environmental conditions can give rise to battery issues. For example, a battery may be damage by storage at a temperature that is low and/or by a temperature that is high. As such, information as to environmental conditions can be utilized, optionally in combination with other information, to make a control action determination. In general, a control action will aim to improve battery behavior, which may help to improve longevity, help to decrease a rate in performance drop, help decrease internal shorting risk, etc. As explained, a method can include issuing one or more notifications, which may be, for example, rendered to a display as part of a graphical user interface. As explained, a notification can be informative to allow a user to know about a state of health of a battery, about a control action or control actions and/or about a recommendation that the user may implement (e.g., store at a lower temperature, store at a higher temperature, do not store beyond X days, etc.).

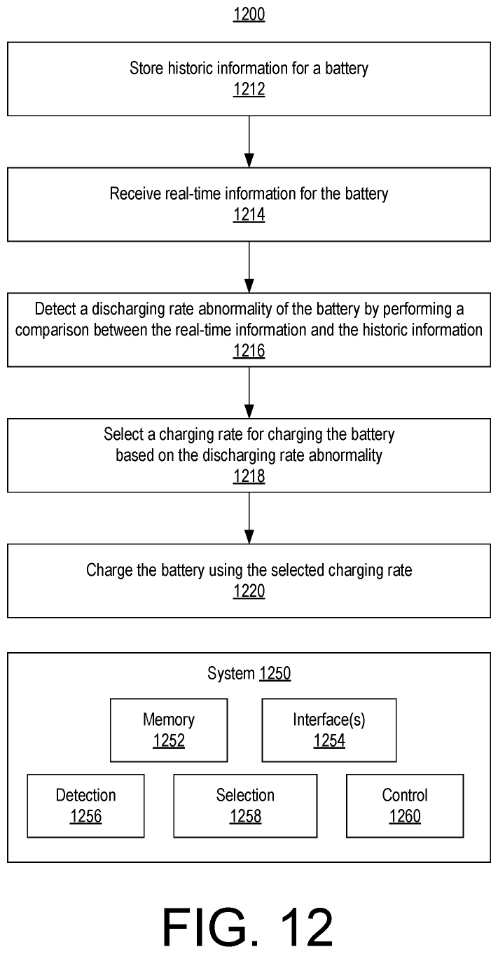

FIG. 12 shows an example of a method 1200 that includes a storage block 1212 for storing historic information for a battery; a reception block 1214 for receiving real-time information for the battery; a detection block 1216 for detecting a discharging rate abnormality of the battery by performing a comparison between the real-time information and the historic information; a selection block 1218 for, based on the discharging rate abnormality, selecting a charging rate for charging the battery; and a charge block 1220 for charging the battery using the selected charging rate.

FIG. 12 also shows an example of a battery system 1250 that can include memory 1252 that stores historic information for a battery; an interface 1254 that receives real-time information for the battery; detection circuitry 1256 that detects a discharging rate abnormality of the battery by a comparison between the real-time information and the historic information; selection circuitry 1258 that, based on the discharging rate abnormality, selects a charging rate for charging the battery; and control circuitry 1260 that calls for charging the battery using the selected charging rate.

As an example, the battery system 1250 may be operatively coupled to one or more batteries. As an example, the battery system 1250 can include one or more batteries.

As an example, the memory 1252 of the battery system 1250 can provide for storage of instructions where circuitry can include a processor (e.g., controller) that can execute such instructions. In such an example, the instructions may provide for performing one or more actions of the method 1200. For example, one or more of the blocks of the method 1200 can be in the form of instructions stored in a computer-readable medium or computer-readable media executable by a processor to cause a system to perform one or more actions.

As explained, a method can include considering a battery's storage history and/or inactivity before charging the battery. In such an example, a charging scheme can be a control scheme that implements one or more control actions to charge the battery in an appropriate manner that can promote battery health, battery performance, etc. In such an example, the one or more control actions may be selected from a group of control actions and/or may be customized for a particular battery based on information regarding its history (e.g., past behavior) and/or its present state (e.g., present behavior). As explained, such information can include usage, storage, environmental, etc., information.

As an example, a method may operate to provide more accurate, individualized control of a battery, for example, based on the battery's own condition and history. Such a method may aim to extend battery life, particularly for high energy density chemistry batteries. As an example, a method may provide for detection of one or more abnormalities in advance of a catastrophic abnormality or other type of abnormality that may be difficult to handle (e.g., an abnormality that may have a substantial impact on performance, continued use, ability to charge, etc.). As explained, detection of an abnormality in an early manner can improve safety, for example, to a device, a battery, a user, etc. As explained, a method may be implemented in a manner to improve user experience.

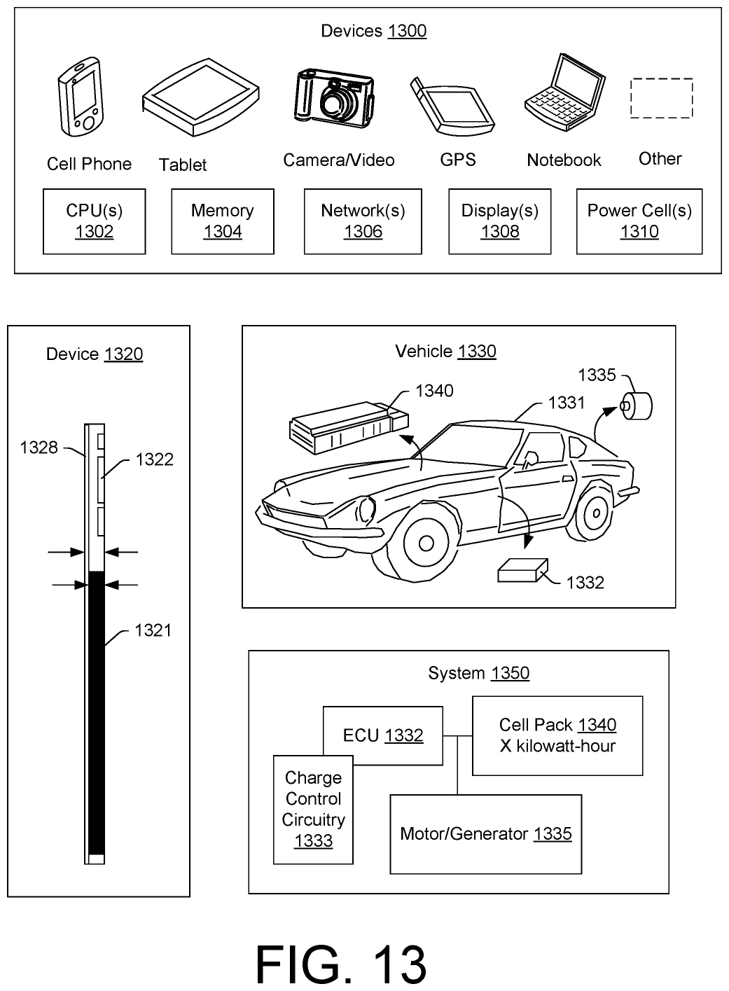

FIG. 13 shows some examples of devices 1300 that may be powered by a battery or batteries (e.g., consider lithium cell or cells (e.g., in the form of a lithium battery or batteries). For example, a cell phone, a tablet, a camera, a GPS device, a notebook computer, or other device may be powered by a lithium cell or cells. As to other devices, a device may be an electric motor of an electric vehicle or a hybrid vehicle. A device may be an automobile, a toy, a remote control device (e.g., a bomb sniffers, drones, etc.), etc. A device may include one or more processors 1302, memory 1304, one or more network interfaces 1306, one or more displays 1308 and, as a power source, one or more power cells 1310 (e.g., lithium-based, etc.).

As an example, a device 1320 may include a power cell(s) 1321, circuitry 1322 and, for example, a display 1328. In such an example, the thickness of the device 1320 may be determined largely by a thickness of the power cell(s) 1321. For example, about 80 percent of the overall thickness of the device 1320 may be determined by a thickness of the power cell(s) 1321.

FIG. 13 also shows an example of a vehicle 1330 that includes an engine control unit (ECU) 1332, a cell pack 1340 and an electric motor and generator 1335 and an example of a system 1350 for the vehicle 1330 that includes the ECU 1332, the cell pack 1340, the electric motor and generator 1335 and charge control circuitry 1333 (e.g., which may be part of the ECU 1332). The vehicle 1330 may include, for example, one or more processors, memory, etc.

As an example, the vehicle 1330 may be a hybrid electric vehicle (HEV) where the cell pack 1340 may, for example, be used to absorb braking energy for immediate re-use in an acceleration cycle (e.g., using the electric motor and generator 1335 as a generator in a regenerative braking scheme). As an example, the vehicle 1330 may be a plug-in hybrid electric vehicle (PHEV) where the cell pack 1340 is rated at about 5.2 kWh to 16 kWh or more, for example, to offer both hybrid and electric drive functions. As an example, the vehicle 1330 may be a battery electric vehicle (BEV) where the cell pack 1340 is rated at about 24 kWh to 200 kWh or more to propel the vehicle 1330.

As an example, a method can include storing historic information for a battery; receiving real-time information for the battery; detecting a discharging rate abnormality of the battery by performing a comparison between the real-time information and the historic information; based on the discharging rate abnormality, selecting a charging rate for charging the battery; and charging the battery using the selected charging rate. In such an example, the historic information can include historic state of charge information with respect to time and, for example, the detecting can detect an increase in a discharging rate of the battery that decreases a state of charge with respect to time where, for example, the selecting the charging rate can include selecting a decreased charging rate that depends on an amount of the increase in the discharging rate, for example, where the selected decreased charging rate can be inversely proportional to the amount of the increase in the discharging rate.

As an example, historic information can include historic environmental information with respect to time and, for example, temperature with respect to time. As an example, a method can include detecting that detects temperatures for a period of time that are in excess of a temperature threshold where, for example, the method can include selecting a charging rate by a process that includes selecting a decreased charging rate that depends a maximum temperature of the temperatures. As an example, a selected decreased charging rate can be inversely proportional to a maximum temperature. As an example, selecting a charging rate can include selecting a decreased charging rate that depends on an integral of temperatures with respect to time.

As an example, a method can include charging a battery using a selected charging rate where such charging occurs incrementally by incrementally charging. In such an example, the method can include generating a charging signature of the battery during the incrementally charging.

As an example, a method can include using historic information that includes voltage information that is acquired in a manner responsive to incrementally charging a battery. In such an example, the voltage information can be indicative of state of charge of the battery. As an example, incrementally charging a battery can include using one or more of gradual trickle charging, multi-step charging, dynamic pulse charging, and mini-boost charging.

As an example, historic information can include usage information indicative of inactivity of a battery associated with non-use. As an example, historic information can include information indicative of use, type of use and/or non-use.

As an example, a battery system can include memory that stores historic information for a battery; an interface that receives real-time information for the battery; detection circuitry that detects a discharging rate abnormality by a comparison between the real-time information and the historic information; selection circuitry that, based on the discharging rate abnormality, selects a charging rate for charging the battery; and control circuitry that calls for charging the battery using the selected charging rate. In such an example, the historic information can include one or more of state of charge information and environmental information.

As an example, one or more non-transitory computer-readable media can include processor-executable instructions to instruct a processor-based controller to: store historic information for a battery; receive real-time information for the battery; detect a discharging rate abnormality by a comparison between the real-time information and the historic information; based on the discharging rate abnormality, select a charging rate for charging the battery; and call for charging the battery using the selected charging rate.

As an example, a computer program product that can include computer-executable instructions to instruct a computing system to perform one or more methods such as one or more of the methods described herein (e.g., in part, in whole and/or in various combinations).

The term “circuit” or “circuitry” is used in the summary, description, and/or claims. As is well known in the art, the term “circuitry” includes all levels of available integration (e.g., from discrete logic circuits to the highest level of circuit integration such as VLSI, and includes programmable logic components programmed to perform the functions of an embodiment as well as general-purpose or special-purpose processors programmed with instructions to perform those functions) that includes at least one physical component such as at least one piece of hardware. A processor can be circuitry. Memory can be circuitry. Circuitry may be processor-based, processor accessible, operatively coupled to a processor, etc. Circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium, which is non-transitory and not a signal or a carrier wave.

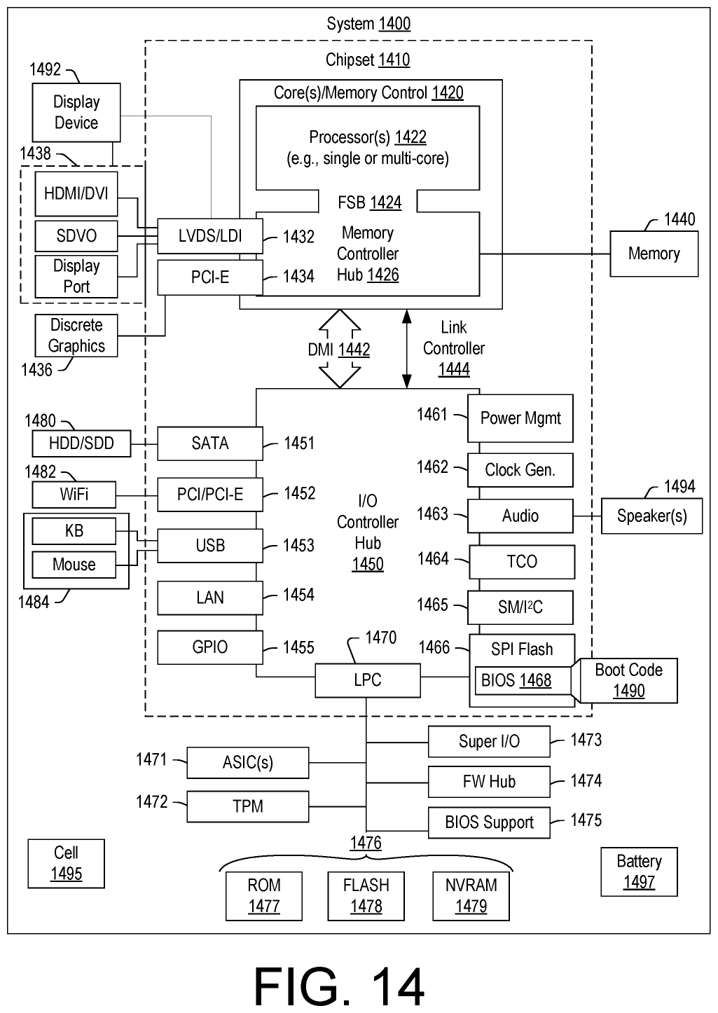

While various examples of circuits or circuitry have been discussed, FIG. 14 depicts a block diagram of an illustrative computer system 1400. The system 1400 may be a computer system, such as one of the ThinkCentre® or ThinkPad® series of personal computers sold by Lenovo (US) Inc. of Morrisville, NC, or a workstation computer system, such as the ThinkStation®, which are sold by Lenovo (US) Inc. of Morrisville, NC; however, as apparent from the description herein, a system or other machine may include other features or only some of the features of the system 1400.

As shown in FIG. 14, the system 1400 includes a so-called chipset 1410. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 14, the chipset 1410 has a particular architecture, which may vary to some extent depending on brand or manufacturer. The architecture of the chipset 1410 includes a core and memory control group 1420 and an I/O controller hub 1450 that exchange information (e.g., data, signals, commands, etc.) via, for example, a direct management interface or direct media interface (DMI) 1442 or a link controller 1444. In the example of FIG. 14, the DMI 1442 is a chip-to-chip interface (sometimes referred to as being a link between a “northbridge” and a “southbridge”).

The core and memory control group 1420 include one or more processors 1422 (e.g., single core or multi-core) and a memory controller hub 1426 that exchange information via a front side bus (FSB) 1424. As described herein, various components of the core and memory control group 1420 may be integrated onto a single processor die, for example, to make a chip that supplants the conventional “northbridge” style architecture.

The memory controller hub 1426 interfaces with memory 1440. For example, the memory controller hub 1426 may provide support for DDR SDRAM memory (e.g., DDR, DDR2, DDR3, etc.). In general, the memory 1440 is a type of random-access memory (RAM). It is often referred to as “system memory”.

The memory controller hub 1426 further includes a low-voltage differential signaling interface (LVDS) 1432. The LVDS 1432 may be a so-called LVDS Display Interface (LDI) for support of a display device 1492 (e.g., a CRT, a flat panel, a projector, etc.). A block 1438 includes some examples of technologies that may be supported via the LVDS interface 1432 (e.g., serial digital video, HDMI/DVI, display port). The memory controller hub 1426 also includes one or more PCI-express interfaces (PCI-E) 1434, for example, for support of discrete graphics 1436. Discrete graphics using a PCI-E interface has become an alternative approach to an accelerated graphics port (AGP). For example, the memory controller hub 1426 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1450 includes a variety of interfaces. The example of FIG. 14 includes a SATA interface 1451, one or more PCI-E interfaces 1452 (optionally one or more legacy PCI interfaces), one or more USB interfaces 1453, a LAN interface 1454 (more generally a network interface), a general purpose I/O interface (GPIO) 1455, a low-pin count (LPC) interface 1470, a power management interface 1461, a clock generator interface 1462, an audio interface 1463 (e.g., for speakers 1494), a total cost of operation (TCO) interface 1464, a system management bus interface (e.g., a multi-master serial computer bus interface) 1465, and a serial peripheral flash memory/controller interface (SPI Flash) 1466, which, in the example of FIG. 14, includes BIOS 1468 and boot code 1490. With respect to network connections, the I/O hub controller 1450 may include integrated gigabit Ethernet controller lines multiplexed with a PCI-E interface port. Other network features may operate independent of a PCI-E interface.

The interfaces of the I/O hub controller 1450 provide for communication with various devices, networks, etc. For example, the SATA interface 1451 provides for reading, writing or reading and writing information on one or more drives 1480 such as HDDs, SDDs or a combination thereof. The I/O hub controller 1450 may also include an advanced host controller interface (AHCI) to support one or more drives 1480. The PCI-E interface 1452 allows for wireless connections 1482 to devices, networks, etc. The USB interface 1453 provides for input devices 1484 such as keyboards (KB), one or more optical sensors, mice and various other devices (e.g., microphones, cameras, phones, storage, media players, etc.). On or more other types of sensors may optionally rely on the USB interface 1453 or another interface (e.g., I²C, etc.). As to microphones, the system 1400 of FIG. 14 may include hardware (e.g., audio card) appropriately configured for receipt of sound (e.g., user voice, ambient sound, etc.).

In the example of FIG. 14, the LPC interface 1470 provides for use of one or more ASICs 1471, a trusted platform module (TPM) 1472, a super I/O 1473, a firmware hub 1474, BIOS support 1475 as well as various types of memory 1476 such as ROM 1477, Flash 1478, and non-volatile RAM (NVRAM) 1479. With respect to the TPM 1472, this module may be in the form of a chip that can be used to authenticate software and hardware devices. For example, a TPM may be capable of performing platform authentication and may be used to verify that a system seeking access is the expected system.

The system 1400, upon power on, may be configured to execute boot code 1490 for the BIOS 1468, as stored within the SPI Flash 1466, and thereafter processes data under the control of one or more operating systems and application software (e.g., stored in system memory 1440). An operating system may be stored in any of a variety of locations and accessed, for example, according to instructions of the BIOS 1468. Again, as described herein, a satellite, a base, a server or other machine may include fewer or more features than shown in the system 1400 of FIG. 14. Further, the system 1400 of FIG. 14 is shown as optionally include cell phone circuitry 1495, which may include GSM, CDMA, etc., types of circuitry configured for coordinated operation with one or more of the other features of the system 1400. Also shown in FIG. 14 is battery circuitry 1497, which may provide one or more battery, power, etc., associated features (e.g., optionally to instruct one or more other components of the system 1400). As an example, a SMBus may be operable via a LPC (see, e.g., the LPC interface 1470), via an I²C interface (see, e.g., the SM/I²C interface 1465), etc.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A method comprising:
storing historic information for a battery;
receiving real-time information for the battery;
detecting a discharging rate abnormality of the battery by performing a comparison between the real-time information and the historic information;
based on the discharging rate abnormality, selecting a charging rate for charging the battery; and
charging the battery using the selected charging rate.

2. The method of claim 1, wherein the historic information comprises historic state of charge information with respect to time.

3. The method of claim 2, wherein the detecting detects an increase in a discharging rate of the battery that decreases a state of charge with respect to time.

4. The method of claim 3, wherein the selecting the charging rate comprises selecting a decreased charging rate that depends on an amount of the increase in the discharging rate.

5. The method of claim 4, wherein the selected decreased charging rate is inversely proportional to the amount of the increase in the discharging rate.

6. The method of claim 1, wherein the historic information comprises historic environmental information with respect to time.

7. The method of claim 6, wherein the historic environmental information comprises temperature with respect to time.

8. The method of claim 7, wherein the detecting detects temperatures for a period of time that are in excess of a temperature threshold.

9. The method of claim 8, wherein the selecting the charging rate comprises selecting a decreased charging rate that depends a maximum temperature of the temperatures.

10. The method of claim 9, wherein the selected decreased charging rate is inversely proportional to the maximum temperature.

11. The method of claim 8, wherein the selecting the charging rate comprises selecting a decreased charging rate that depends on an integral of the temperatures with respect to time.

12. The method of claim 1, wherein the charging the battery using the selected charging rate comprises incrementally charging.

13. The method of claim 12, comprising generating a charging signature of the battery during the incrementally charging.

14. The method of claim 1, wherein the historic information comprises voltage information responsive to incrementally charging the battery.

15. The method of claim 14, wherein the voltage information is indicative of state of charge of the battery.

16. The method of claim 14, wherein the incrementally charging the battery comprises using one or more of gradual trickle charging, multi-step charging, dynamic pulse charging, and mini-boost charging.

17. The method of claim 1, wherein the historic information comprises usage information indicative of inactivity of the battery associated with non-use.

18. A battery system comprising:
memory that stores historic information for a battery;
an interface that receives real-time information for the battery;
detection circuitry that detects a discharging rate abnormality of the battery by a comparison between the real-time information and the historic information;
selection circuitry that, based on the discharging rate abnormality, selects a charging rate for charging the battery; and
control circuitry that calls for charging the battery using the selected charging rate.

19. The battery system of claim 18, wherein the historic information comprises one or more of state of charge information and environmental information.

20. One or more non-transitory computer-readable media comprising processor-executable instructions to instruct a processor-based controller to:
store historic information for a battery;
receive real-time information for the battery;
detect a discharging rate abnormality of the battery by a comparison between the real-time information and the historic information;
based on the discharging rate abnormality, select a charging rate for charging the battery; and
call for charging the battery using the selected charging rate.
